(19) United States
(12) Patent Application Publication
(10) Pub. No.: US 2010/0041398 A1
(43) Pub. Date: Feb. 18, 2010

(54) Method for providing wireless subscriber services

(76) Inventors: Donna Michaels Sand, Redmond, WA (US); Robin Jeffrey Thompson, Batavia, IL (US); Gregory Tevonian, North Aurora, IL (US)

Correspondence Address: HARNESS, DICKEY & PIERCE, P.L.C., P.O. BOX 8910, RESTON, VA, 20195, US

(21) Appl. No.: 12/461,503

(22) Filed: Aug. 13, 2009

Related U.S. Application Data
(60) Provisional application No. 61/188,901, filed on Aug. 14, 2008.

(51) Int. Cl. H04W 4/00

(52) U.S. Cl. 455/433

(57) ABSTRACT

A system for providing wireless services to a first user on the system includes a first application server coupled to a home location register and configured to provide wireless services to the first user. The home location register is configured to store information regarding the first user. A second application server is configured to provide wireline services to the first user and coupled to a media resource function. The media resource function is configured to produce tones and announcements. The second application server is further configured to interact with the first application server to provide an interface to the media resource function.

### PRIORITY STATEMENT

This application claims the benefit of U.S. Provisional Application No. 61/188,901, filed Aug. 14, 2008.

### BACKGROUND

IP Multimedia Subsystem (IMS) was developed by 3^{rd} Generation Partnership Project (3GPP) to provide multimedia services using Internet Protocol (IP).

IP Multimedia Subsystem telephony application servers (TAS) have been developed for wireline services and do not have a wireless network interface for subscriber services data retrieval from a Home Location Register (HLR). On the other hand, there are IMS interworking or convergence servers designed to provide an interface to a wireless or mobility network, but these devices are not full telephony application servers and do not have the capability to provide a full range of subscriber supplementary services such as call hold, three way calling, and other services that require connection and control of a media resource function for tones and announcements or conference bridges.

The need for such an IMS function has been addressed by adding the wireless services and mobility network interfaces to a wireline TAS. However, adding wireless services and mobility network interfaces to a conventional TAS incurs significant development system redesign.

### SUMMARY

Example embodiments provide a system for providing wireless services to a first user on the system. The system includes a first application server coupled to a home location register and configured to provide wireless services to the first user. The home location register is configured to store information regarding the first user. A second application server is configured to provide wireline services to the first user and coupled to a media resource function. The media resource function is configured to produce tones and announcements. The second application server is further configured to interact with the first application server to provide an interface to the media resource function.

At least one other example embodiment provides for a method for providing wireless services to a first user on a system. The method includes receiving, at a first application server, a request from the first user to activate a service. The first application server is configured to provide wireless services to the first user. The method further includes determining, at the first application server, a service to provide based on the request and sending, from the first application server, an instruction to a second application server to provide the service based on the determining step. The second application server is configured to provide wireline services to the first user and interact with the first application server to provide an interface to a media resource function configured to produce tones and announcements associated with the service.

Another example embodiment provides for a method for providing wireless services to a first user on a system. The method includes first receiving, at a first application server, a call request from a third user during an existing call between the first user and a second user. The first application server is configured to provide wireless services to the first user and a second application server is configured to provide wireline services to the first user and interact with a first application server to provide an interface to a media resource function configured to produce tones and announcements. The method further includes first transmitting, by the first application server, to a second application server an invite to answer the call request from the third user, second receiving, at the first application server, an instruction from the second application server to start a call waiting tone and second transmitting, by the first application server, a reinvite signal to reestablish the first call.

### BRIEF DESCRIPTION OF THE DRAWINGS

Example embodiments will be more clearly understood from the following detailed description taken in conjunction with the accompanying drawings. FIGS. 1-5G represent non-limiting, example embodiments as described herein.

FIG. 1 illustrates an IMS network according to an example embodiment;

FIGS. 2A-2B illustrate an example embodiment of a wireless mobile served by an IMS network that is on an active voice call and attempts to activate a feature such as call forwarding;

FIGS. 3A-3B illustrate an origination call barring in an IMS network according to an example embodiment;

FIGS. 4A-4G illustrate an example embodiment of a method of controlling a media resource function (MRF) on a second leg of three way calling for an Mobile Application Part (MAP) Femto Interworking Function (MFIF) in an IMS; and

FIGS. 5A-5G illustrate an example embodiment of a method of controlling interaction between a TAS and a MFIF in a call process in an IMS.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Example embodiments provide methods for adding mobility specific features, including features driven by dynamic data from a mobility network home location register (HLR), to a wireless network interworking server sometimes called the MAP Femto Interworking Function (MFIF). The mobility features may be used while continuing to use wireline telephony applications for more complicated operations such as mid-call features that use call path reconfiguration (e.g., call waiting, three-way calling, and call transfer applications).

Wireless subscriber services may be provided in an IMS. The wireless subscriber services may be provided in an IMS based dual mode (e.g. CDMA/Voice over Wi-Fi) services and/or CDMA Femto Access Point. More specifically, wireless subscriber services may be provided in a system including a wireless network interworking server (MFIF) and a wireline supplementary services application server (TAS).

The TAS may include software to interwork with the MFIF. The software may be encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. Example embodiments are not limited by these aspects of any given implementation.

The MFIF may provide an interface to a wireless network and wireless network specific services, or services that are dynamically driven by data in the wireless network. The TAS provides services that are not specific to the wireless network or wireless subscriber data.

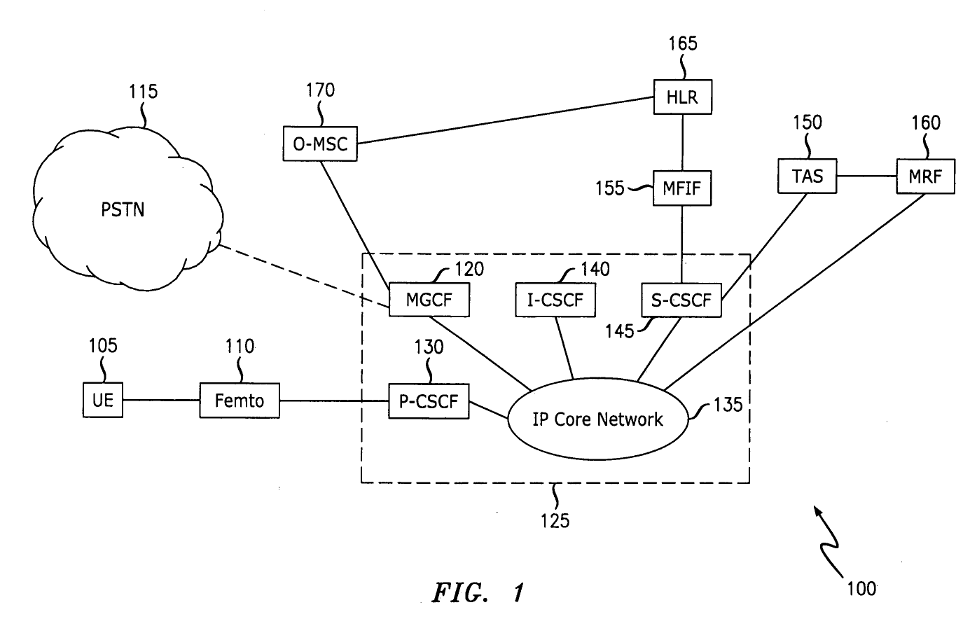

FIG. 1 illustrates an IMS network according to an example embodiment. An IMS network 100 may be accessed by a subscriber using a user equipment (UE) 105 connected to the IMS network through an access node. In the example shown in FIG. 1, the access node may be a femto base station 110. The UE 105 is a mobile device that is capable of accessing the public telephone network via base stations. The Femto base station is one type of base station.

The femto base station 110 and a public switched telephone network (PSTN) 115 are connected to a call session control function (CSCF) 125. In more detail, the PSTN 115 may be connected to the CSCF 125 (and the IMS network 100) through a media gateway controller function (MGCF) 120. The MGCF 120 performs protocol conversion between the circuit network protocols used by the PSTN 115 and the IP protocols used by the CSCF 125.

The CSCF 125 may receive and process signaling packets in the IMS network 100. The CSCF 125 includes the MGCF 120, a proxy-CSCF (P-CSCF) 130, and IP Core Network 135, a serving-CSCF (S-CSCF) 145 and an interrogating-CSCF (I-CSCF) 140. These well-known IMS elements are further defined in 3GPP TS 23.228 V8.5.0.

The IMS network 100 further includes a telephony application server (TAS) 150 (a second application server) and a wireless network interworking server (MFIF) 155 (a first application server) connected to the CSCF 125. The wireless network interworking server is named the MFIF (Mobile Application Part (MAP) Femto Interworking Function) in this application. The wireless networking server may alternatively be a convergence server. Both the TAS 150 and MFIF 155 may send and receive signals from the S-CSCF 145.

A media resource function (MRF) 160 is connected to the TAS 150, either directly or through the IP Core Network. The MRF 160 performs media related functions such as producing tones and announcement. Examples of tones and announcements include playing call denial announcements when a call barring service blocks a call request, or mapping received Session Initiation Protocol (SIP) error codes into specific denial announcements, or playing confirmation announcements after services have been activated or deactivated by the user.

A home location register (HLR) 165 is connected to the MFIF 155 and an originating mobile switching center (O-MSC) 170. The O-MSC 170 is also connected to the MGCF 120. The HLR 165 stores details regarding subscribers that access the IMS network 100, such as calling permissions (e.g., international or not, blocked area codes) and activation status of features such as call forwarding, busy, don't answer and forward to destination for each type of call forwarding.

The MFIF 155 may provide HLR registration, mobile profile (e.g., visitor location register (VLR)) download and interface updates. The MFIF 155 may provide for mobiles services that cause or depend heavily on HLR based dynamic data such as feature activation notification, origination restrictions including a hotline to a pre-provisioned destination, service options support such as packet data and short message service (SMS), voice privacy support and call forwarding activation status. The hotline may be used by a service provider to cause all calls originating from a user to route to a pre-provisioned number.

The TAS 150 and the MFIF 155 interact to jointly provide services. More specifically, the MFIF 155 provides an interface to the HLR 165 and the TAS 150 is used to provide services that involve call reconfigurations (such as call waiting, three way calling, and call transfer) and connection to the MRF 160 to provide tones and announcements.

The TAS 150 may be configured to provide services assigned to individual subscribers, or may be configured to provide the same set of services to all subscribers attached to the IMS network 100 through a femto access point.

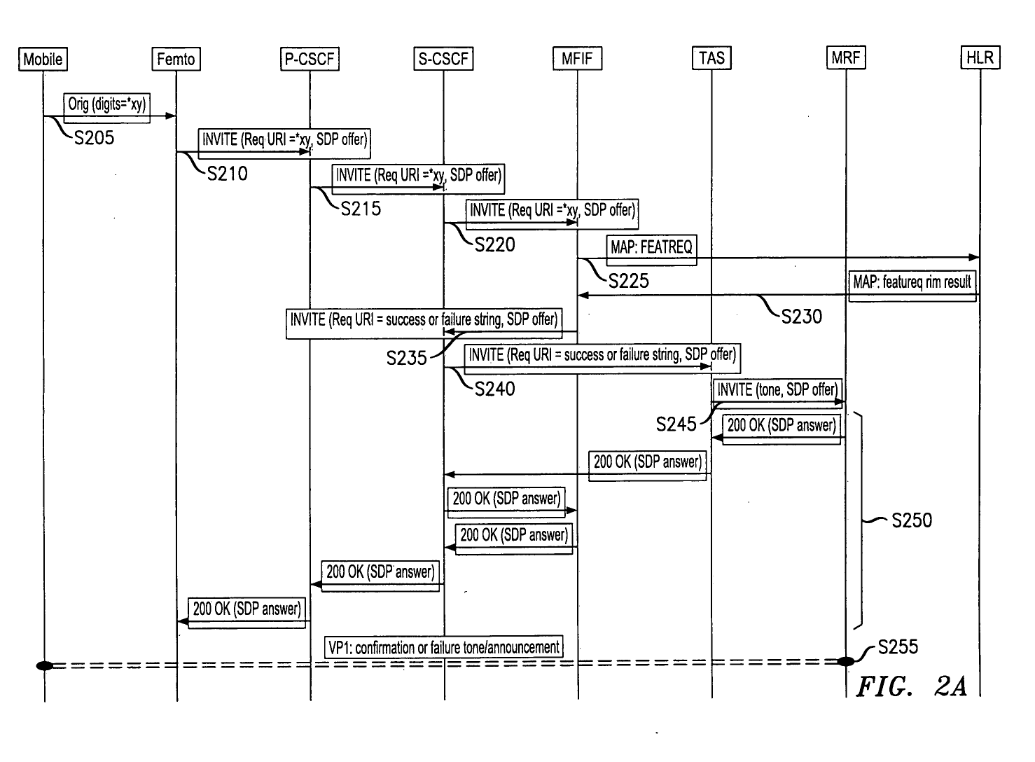

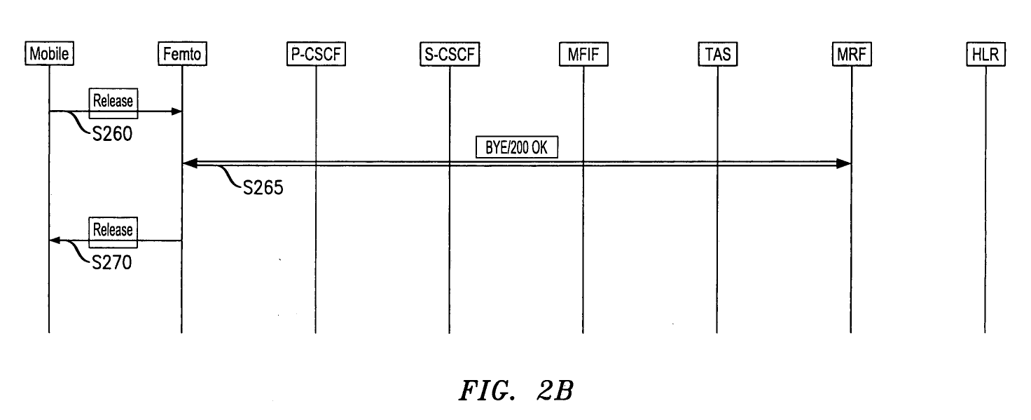

FIGS. 2A-5G illustrate example embodiments. It should be understood that FIGS. 2A-5G may be implemented as program modules or functional processes include routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like.

FIGS. 2A-2B illustrate an example embodiment of a wireless mobile device served by an IMS network, where a subscriber attempts to activate or deactivate a feature, such as call forwarding. FIGS. 2A-2B illustrate that a MFIF receives a SIP INVITE request that contains a dialed service access code to activate or deactivate the feature, and the MFIF then sends an INVITE to the TAS with instruction to play an announcement. An INVITE is known to one of ordinary skill in the art and therefore, will not be described in detail. The IMS may be the IMS network 100 that is illustrated in FIG. 1.

At S205, a mobile dials a service access code (activation code), such as a call forwarding service access code. The femto receives the activation code, at S210, and sends a SIP INVITE request to the P-CSCF, using a Request URI that contains the dialed service access code and a Session Description Protocol (SDP) offer.

The P-CSCF forwards the INVITE request to a S-CSCF, at S215, and the S-CSCF forwards the INVITE to a MFIF, at S220.

The MFIF performs an activation code evaluation and determines whether a feature activation procedure should be performed. More specifically, the MFIF compares the Request URI to a list of provisioned activation codes. The provisioned activation codes are stored in the MFIF. The provisioned activation codes may be updated at anytime through a provisioning interface to the MFIF, consistent with how feature access codes are provisioned into a wireless mobile switching center (MSC). If the Request URI matches a provisioned activation code then the MFIF forwards a feature request associated with the matching activation code to a HLR, at S225. The feature request message (FEATREQ) is one of the messages defined in MAP, which is a well-known protocol.

The HLR updates subscription data for the mobile device. After updating the data, the HLR forwards a success or failure indication to the MFIF, at S230. The MFIF then changes the Request URI into a success or failure string that will be recognized by the TAS as a request to play a tone or announcement.

The MFIF sends an INVITE request that contains the success or failure string and the SDP offer to the S-CSCF, at S235. At S240, the INVITE is forwarded to a TAS. The TAS analyzes the value of the Request URI in the INVITE using data defined in the TAS, and determines that the Request URI is a request to play a specific tone or announcement, at S245. The TAS sends an INVITE request to an MRF, with an instruction to play the specific tone or announcement derived from the received success or failure string. Since the TAS determines the appropriate announcement to be used and interacts with the MRF, the wireless side (including the MFIF and the femto) does not have to manage announcements and the MRF. The announcements and tones used by the TAS can be shared by both wireline and wireless subscribers.

At S250, 200 OK acknowledgments are sent from the MRF to the TAS, then from the TAS to the S-CSCF, then from the S-CSCF to the MFIF, then from the MFIF to the S-CSCF, then from the S-CSCF to the P-CSCF and then from the P-CSCF to the femto. 200 OK acknowledgments are well-known, therefore, a detailed description thereof will be omitted for the sake of clarity and brevity.

After the acknowledgments have been sent, the caller hears the confirmation or failure tone/announcement, at S255, over a voice path VP1. The mobile device then releases the femto, at S260, if the mobile device hangs up before the tone/announcement ends. At S265, the MRF is released with a BYE request and a corresponding 200 OK BYE acknowledgment. At S270, the femto releases the mobile device if the tone/announcement ends.

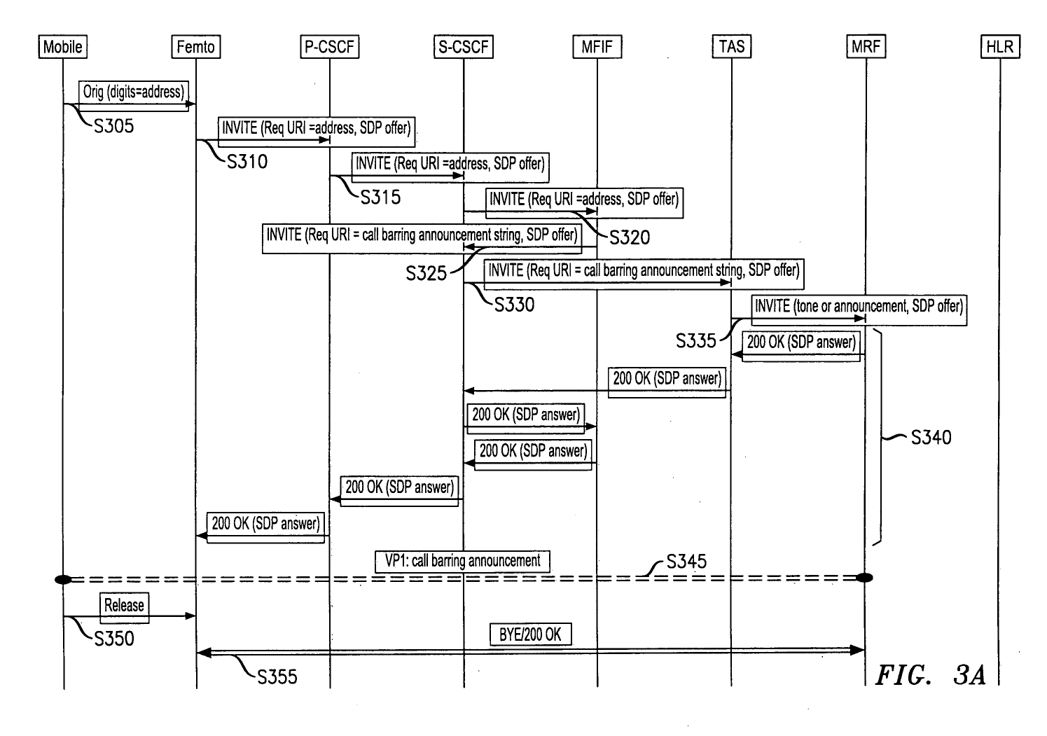

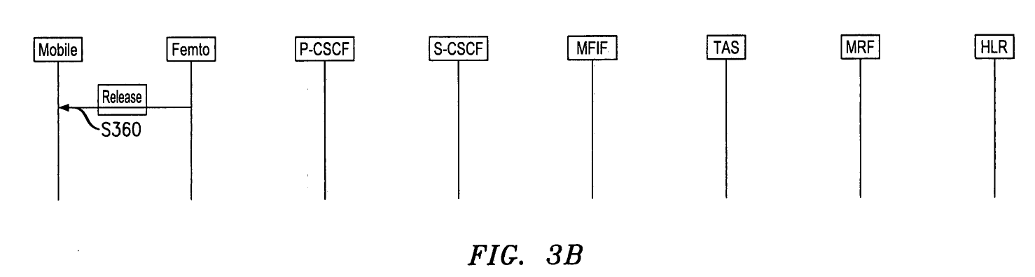

FIGS. 3A-3B illustrates an example embodiment where a call attempt is rejected by a call barring service running in the MFIF, and the MFIF requests that the TAS provide a denial announcement to the caller. The IMS may be the IMS network 100 that is illustrated in FIG. 1.

In the method of FIGS. 3A-3B, a mobile is registered with an MFIF and a call barring feature is active. A call barring feature prohibits a mobile from making international calls, for example. A MFIF and TAS may be provisioned with a call barring announcement digit string and treatment. For example, a play call barring rejection string is defined on both the MFIF and TAS. The play call barring rejection string maps to an announcement file on the TAS. Therefore, the MFIF may communicate an action to be taken by the TAS.

Steps S305-S320 are the same as steps S205-S220 except that the Request URI of the INVITE contains a dialed destination number rather than a service access code. Therefore, for the sake of clarity and brevity, S305-S320 will not be described in more detail.

When the MFIF receives the INVITE request with a destination number in the Request URI, the MFIF analyzes the digits and determines whether originating call barring applies. If the MFIF determines that the call should be barred, the MFIF replaces the Request URI with a call barring announcement string. The MFIF sends the INVITE to a S-CSCF, at S325, and the S-CSCF then sends the INVITE to a TAS, at S330.

Just as in FIGS. 2A-2B, the TAS analyzes the value of the Request URI received in the INVITE request, and maps the string to the provisioned announcement used for call barring. At S335, the TAS sends an INVITE request, including the SDP offer, to the MRF to play the call barring tone or announcement.

At S340, 200 OK acknowledgments with an SDP answer are sent from the MRF to the TAS, then from the TAS to the S-CSCF, then from the S-CSCF to the MFIF, then from the MFIF to the S-CSCF, then from the S-CSCF to the P-CSCF and then from the P-CSCF to the femto.

At S345, the caller is hearing the call barring announcement that is played from the MRF over the voice path VP1. The mobile device then releases the femto, at S350, if the mobile device hangs up before the announcement ends. At S355, the procedures to release the MRF, as illustrated in FIG. 2, are followed and the MRF is released. These steps are not shown in detail in FIGS. 3A-3B. At S360, the femto releases the mobile if the announcement ends.

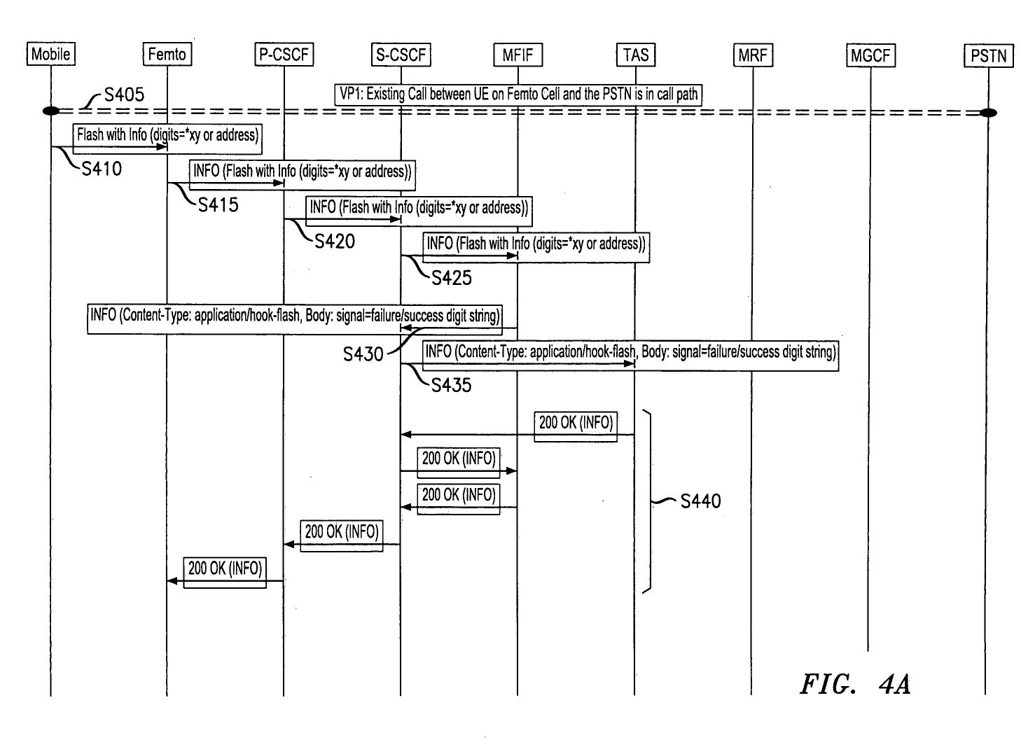

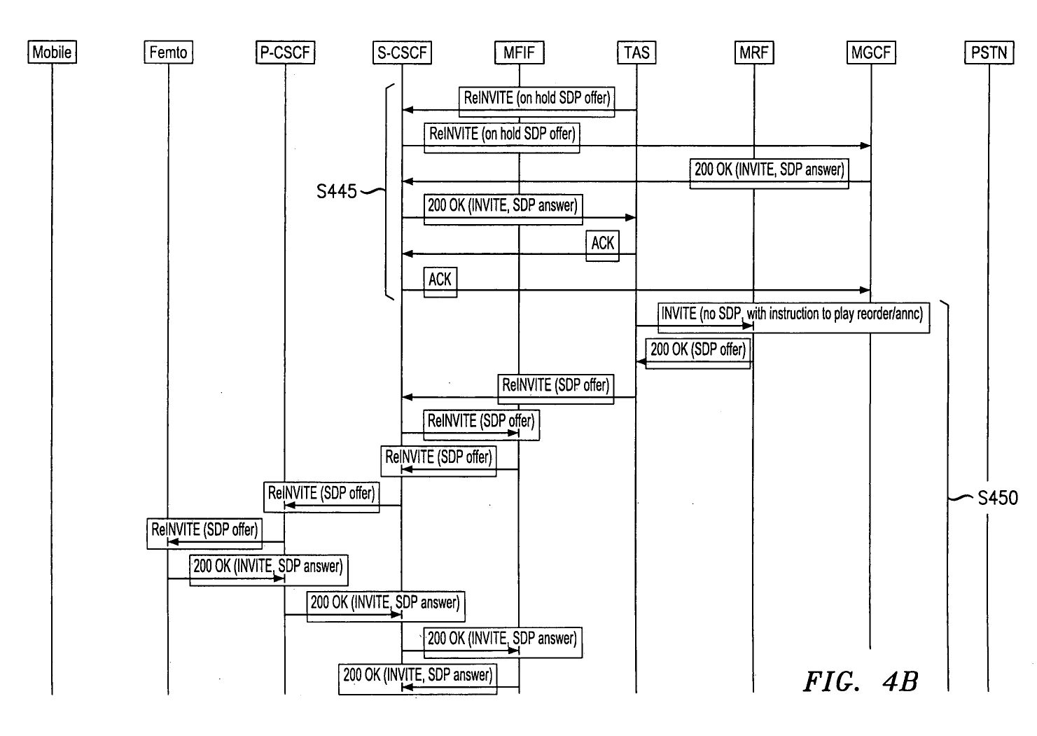

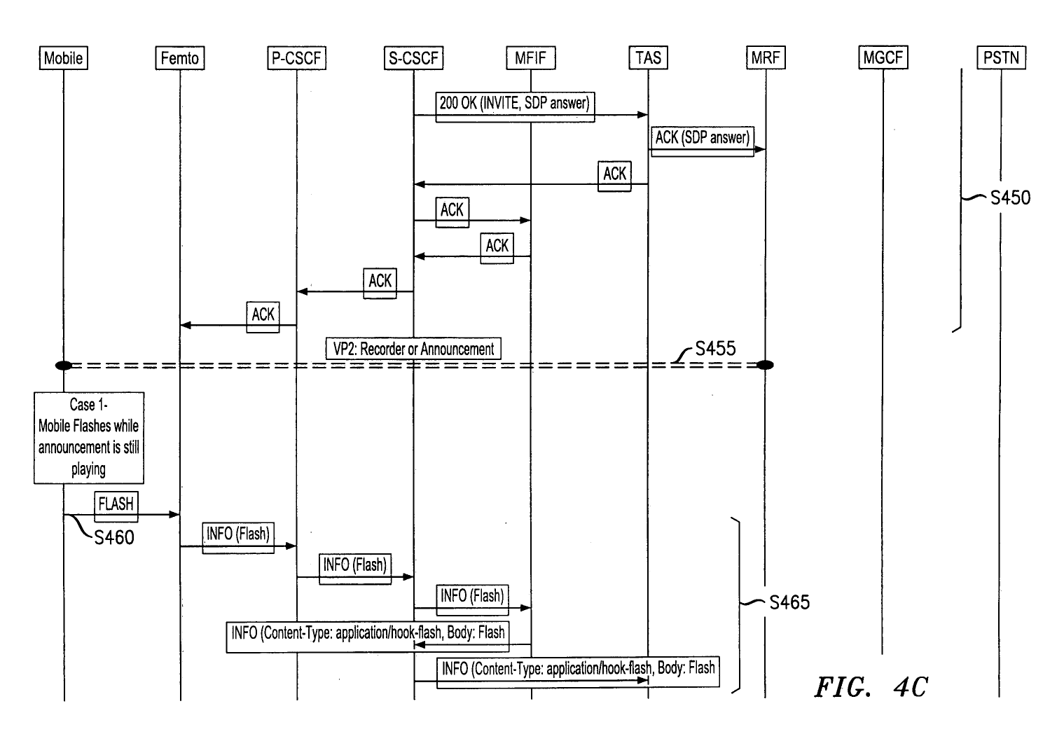

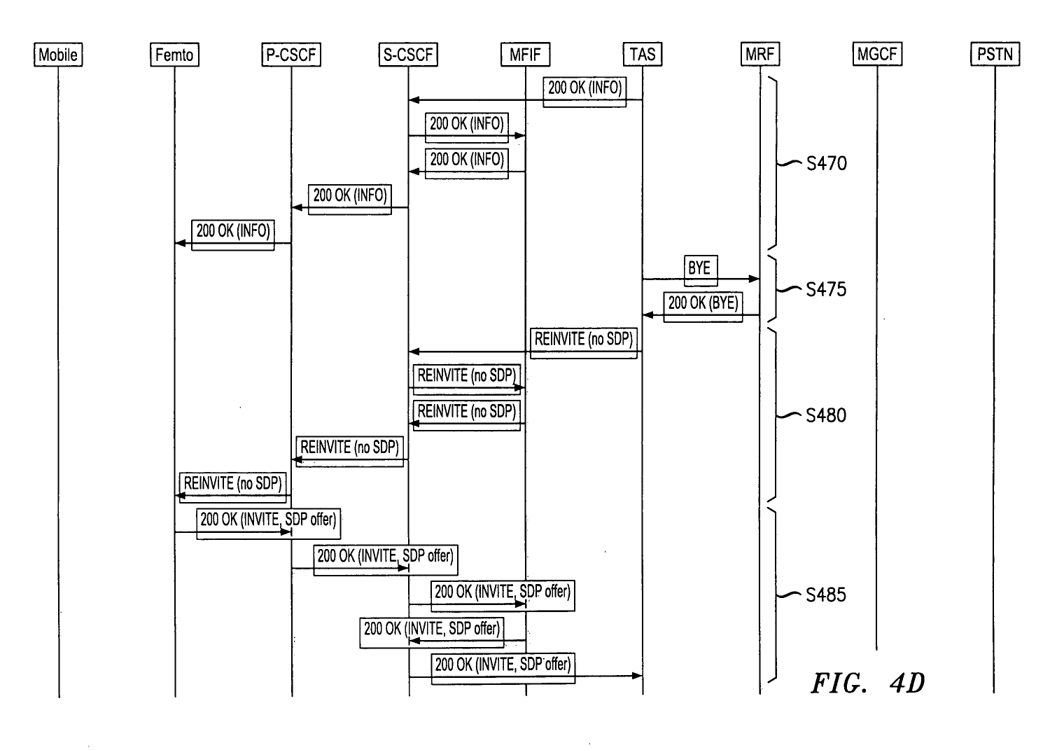

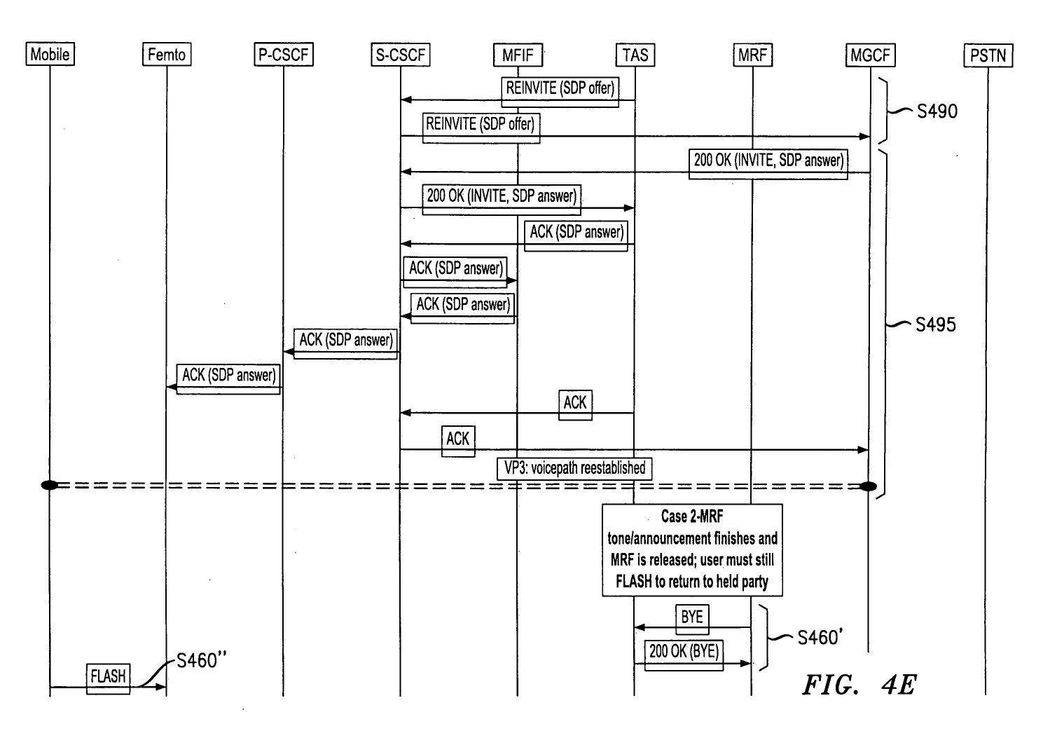

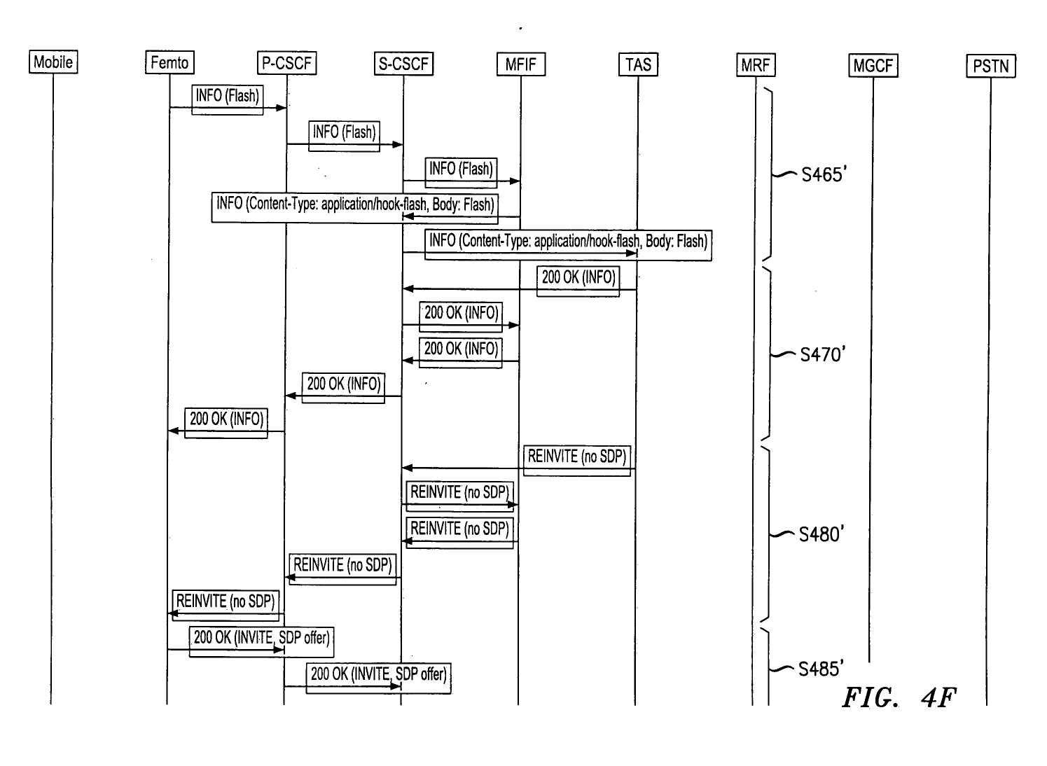

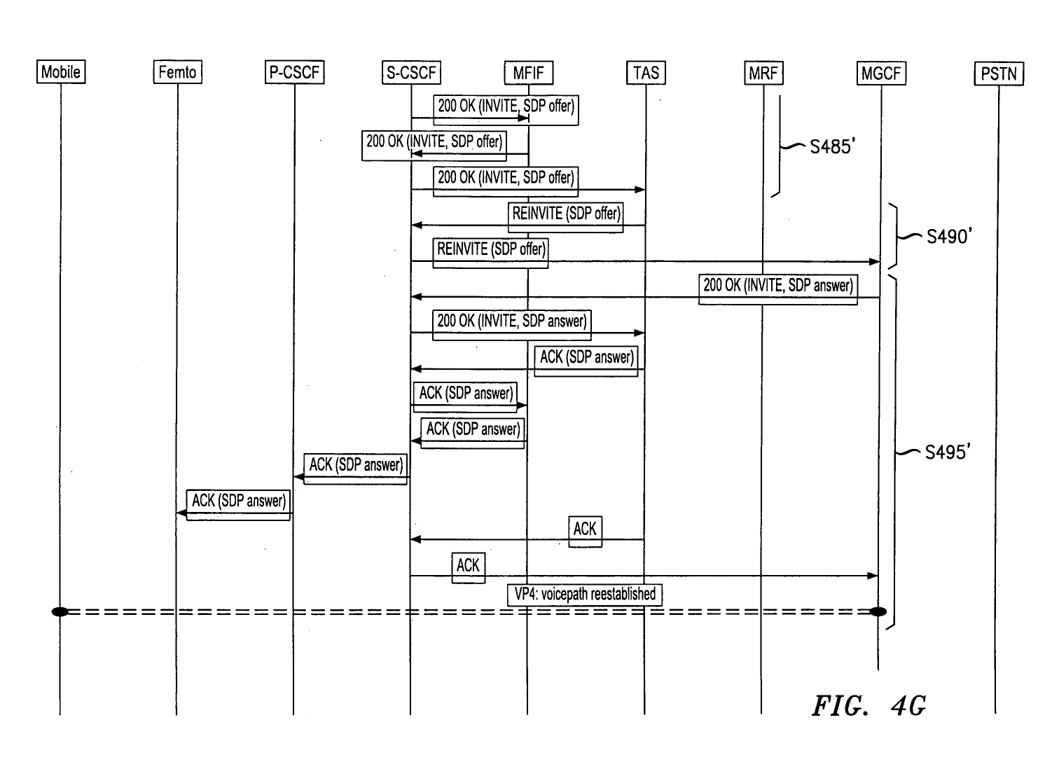

FIGS. 4A-4G illustrate an example embodiment of a method of providing a tone or announcement while already active on a call. In FIGS. 4A-4G, an active call exists between the mobile device and another party, and then the caller uses a “flash”, “send” or “talk” key on the mobile device to make a second call. The second call may be dialed with a service access code (as in FIGS. 2A-2B), or may be a request to place a second outbound call (as in FIGS. 3A-3B). The IMS may be the IMS network 100 that is illustrated in FIG. 1.

At S405, there is an existing call between first and second users. The first user is a wireless subscriber using a mobile on a femto cell and the second user may be in a PSTN, in the IMS, or in another network. When the first user presses the “flash”, “talk”, or “send” button on the mobile device and then dials digits (the specific sequence of key presses may vary based on the particular mobile device), the device sends a “flash” message to the femto, along with the dialed digits, at S410. The dialed digits may be a service access code or a complete destination number. In this example, the caller may dial a service code to disable call waiting, such as “*70”.

Because the dialed digit string was entered while a prior call exists, a SIP INFO request is used to carry the dialed digits, rather than a SIP INVITE request. At S415, the femto sends a SIP INFO request to the P-CSCF. The INFO request includes the digits dialed by the first user. At S420, the INFO is sent from a P-CSCF to a S-CSCF and, at S425, the INFO request is sent from the S-CSCF to a MFIF.

The MFIF analyzes the dialed digit string received in the SIP INFO request, as is done in S225 of FIG. 2A and S325 of FIG. 3A.

As illustrated in FIGS. 2A-2B and FIGS. 3A-3B, the MFIF analyzes the received digits and determines whether the request will be honored and whether a tone or announcement should be played to the first user. In this example shown in FIGS. 4A-4G, the SIP INFO request has been honored. However, it should be understood that the SIP INFO request may not be honored.

At S430, the MFIF sends a SIP INFO request with a failure/success string to the S-CSCF. The SIP INFO request is then sent to the TAS from the S-CSCF, at S435. The MFIF sends an INFO request to the TAS with an instruction to play a confirmation tone that lets the first user know that the SIP INFO request to disable call waiting has been accepted. As shown, the parameters in the INFO request include application/hook-flash as the Content-Type and the failure/success string as the body.

At S440, the TAS confirms receipt of the SIP INFO request by sending a 200 OK acknowledgment to the S-CSCF which is then sent to the MFIF, back to the S-CSCF, to the P-CSCF and to the femto.

The TAS analyzes the digit string received in the body of the INFO request, just as the TAS had analyzed the digit string received in the Request URI of the INVITE in FIGS. 2A-2B and FIGS. 3A-3B. If the digit string is recognized as a request to play an announcement, the active call is put on hold with standard SIP REINVITE procedures, at S445, and the first user is connected to an MRF to hear the requested announcement. If the digits string is recognized as a destination number, the active call is put on hold, at S445, and the TAS attempts to connect the first user to the dialed destination.

In parallel with acknowledging the INFO request, the TAS places the second user that was active on hold, at S445. The TAS manages call legs between the subscriber (e.g., first user) and the far parties (e.g., second user and third user). Thus, the TAS ensures that there is no more than one active RTP stream between the first user and the IMS network. The TAS puts the second user on hold by sending a SIP REINVITE request that contains an on hold SDP offer to the S-CSCF. The REINVITE is sent from the S-CSCF to the MGCF. The MGCF replies to the REINVITE by sending a 200 OK that includes an SDP answer to the S-CSCF. The 200 OK is sent to the TAS. The TAS sends a SIP ACK back to the S-CSCF and the S-CSCF sends the ACK to the MGCF.

Also in parallel with putting the second user on hold, the TAS creates a connection to an MRF so the first user can hear the announcement that has been requested by the MFIF. At S450, the TAS sends an INVITE request to the MRF, just as was done in FIGS. 2A-2B and FIGS. 3A-3B. Unlike the examples in FIGS. 2A-2B and FIGS. 3A-3B, an active session description protocol (SDP) session has already been established between the first user and the IMS network, so the TAS uses standard SIP REINVITE procedures to connect the first user to the MRF. In this example, the announcement is a confirmation that call waiting has been disabled.

During the SDP renegotiation, at S450, the TAS sends an INVITE request to the MRF. The INVITE includes an instruction to play the announcement. The MRF sends back to the TAS a 200 OK with an SDP offer. A REINVITE with the SDP offer is then sent from the TAS to the S-CSCF, to the MFIF, to the S-CSCF, to the P-CSCF and to the femto. The femto replies to the REINVITE by sending a 200 OK (with an SDP answer) to the P-CSCF. The 200 OK is sent from the P-CSCF to the S-CSCF, to the MFIF, to the S-CSCF and to the TAS. The TAS then sends the SDP answer to the MRF in the SIP ACK. SIP ACK messages are then sent from the TAS to the S-CSCF, then from the S-CSCF to the MFIF, then from the MFIF to the S-CSCF, then from the S-CSCF to the P-CSCF and then from the P-CSCF to the femto.

The MRF plays the requested announcement, at S455, over a voice path VP2. There may be two variations to the flow once the requested announcement is played by the MRF. If the mobile device flashes while the announcement is still playing, the MRF is dropped and the TAS will use REINVITE procedures to reconnect the first user and second user (steps beginning at S460). If the announcement is finished and the MRF has already been released by the TAS before the first user flashes, the TAS will also reconnect the first user and second user with standard REINVITE procedures (steps beginning at S460′).

Once the mobile flashes at S460, while the announcement is still playing, the TAS is informed that there is a flash, at S465. More specifically, the femto sends a SIP INFO request that indicates that the user has flashed to the P-CSCF, then from the P-CSCF to the S-CSCF, then from the S-CSCF to the MFIF. The MFIF sends the INFO request to the S-CSCF and the S-CSCF then sends the INFO to the TAS. Since there are no associated digits with the flash, the message body of the INFO only indicates that flash was used.

The INFO request is treated by the TAS as a request to drop the MRF and reconnect to the second user. At S470, the TAS acknowledges that the SIP INFO request has been received. The TAS releases the MRF, at S475.

At S480, a REINVITE is sent from the TAS toward the femto to obtain a new SDP offer. As shown in FIGS. 4A-4G, the REINVITE follows the following path: to the S-CSCF, then from the S-CSCF to the MFIF, then from the MFIF back to the S-CSCF, then from the S-CSCF to the P-CSCF and then from the P-CSCF to the femto.

At S485, the femto sends a 200 OK response that contains an SDP answer. The 200 OK traverses the P-CSCF, the S-CSCF, and the MFIF and then is sent from the MFIF back to the S-CSCF, which forwards the 200 OK to the TAS.

The TAS sends a REINVITE including the SDP offer to the MGCF connected to the second user through the S-CSCF, at S490.

At S495, the MGCF sends a 200 OK response that contains an SDP answer, and this 200 OK is propagated back to the TAS. The TAS puts the SDP answer into an ACK that is then propagated back to the femto. A voice path is then reestablished between the first user and the second user.

As stated above, if the announcement is finished, at S455, and the MRF is released, a user flash will also result in reconnection to the second user, but the TAS does not release the MRF since the MRF has already been dropped.

At S460′, the MRF is released from the TAS. At S460″, the first user flashes and the flash notification is sent to the femto.

From S460″, the process proceeds to S465′, S470′, S480′, S485′, S490′ and S495′. S460″, S465′, S470′, S480′, S485′, S490′ and S495′ are the same as S460, S465, S470, S480, S485, S490 and S495. Therefore, for the sake of brevity and clarity, a description of S460″, S465′, S470′, S480′, S485′, S490′ and S495′ will be omitted. Since the MRF is released from the TAS at S460′, a step corresponding to S475 may be omitted.

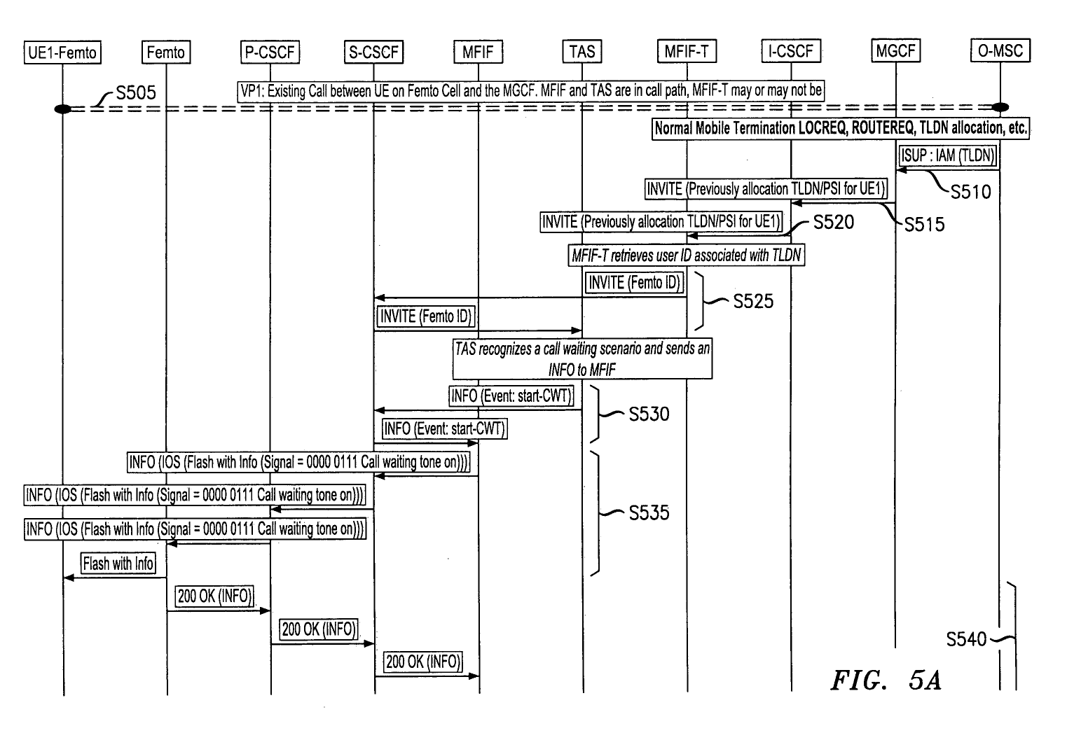

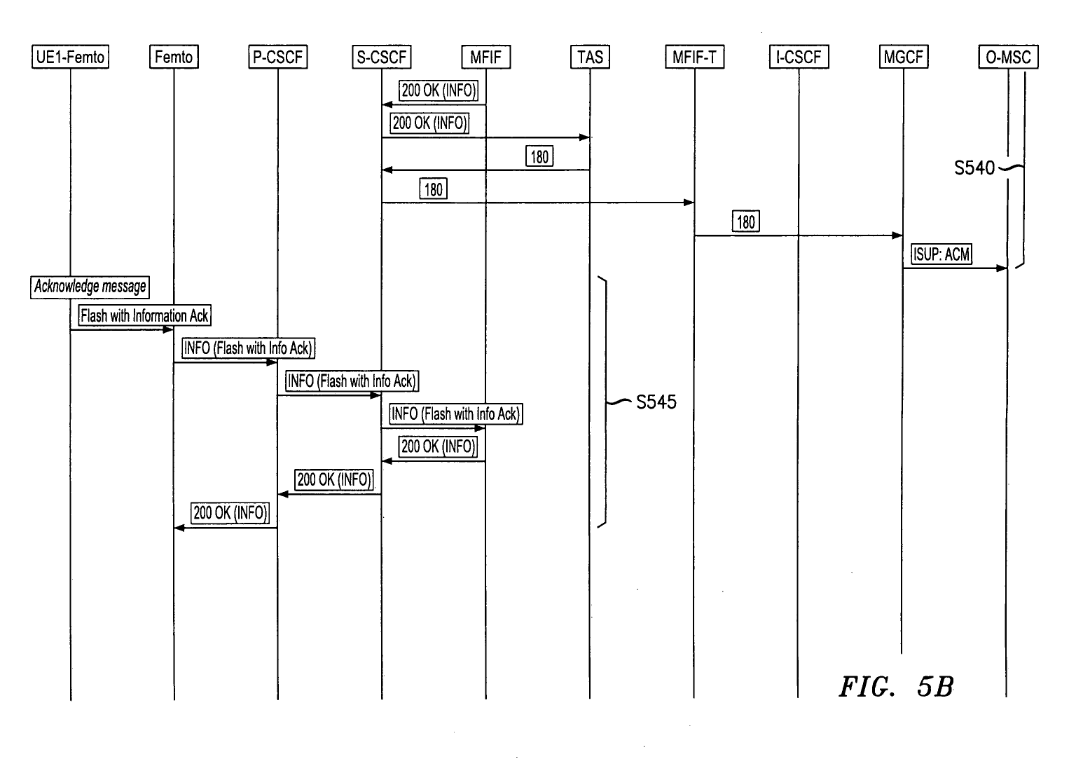

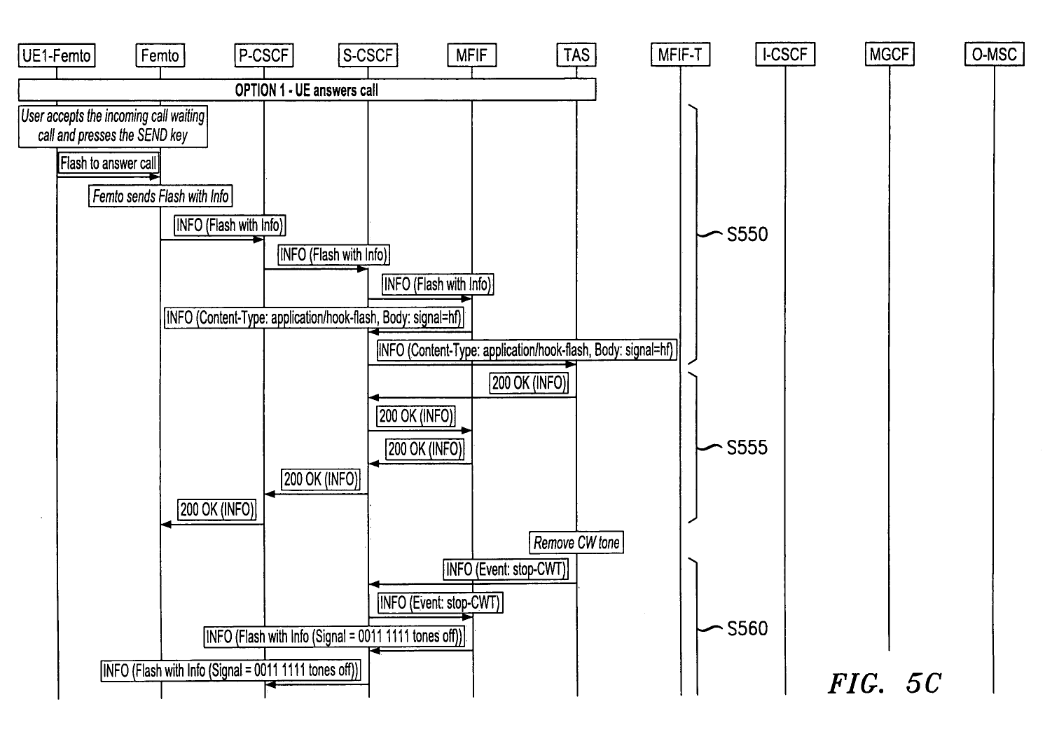

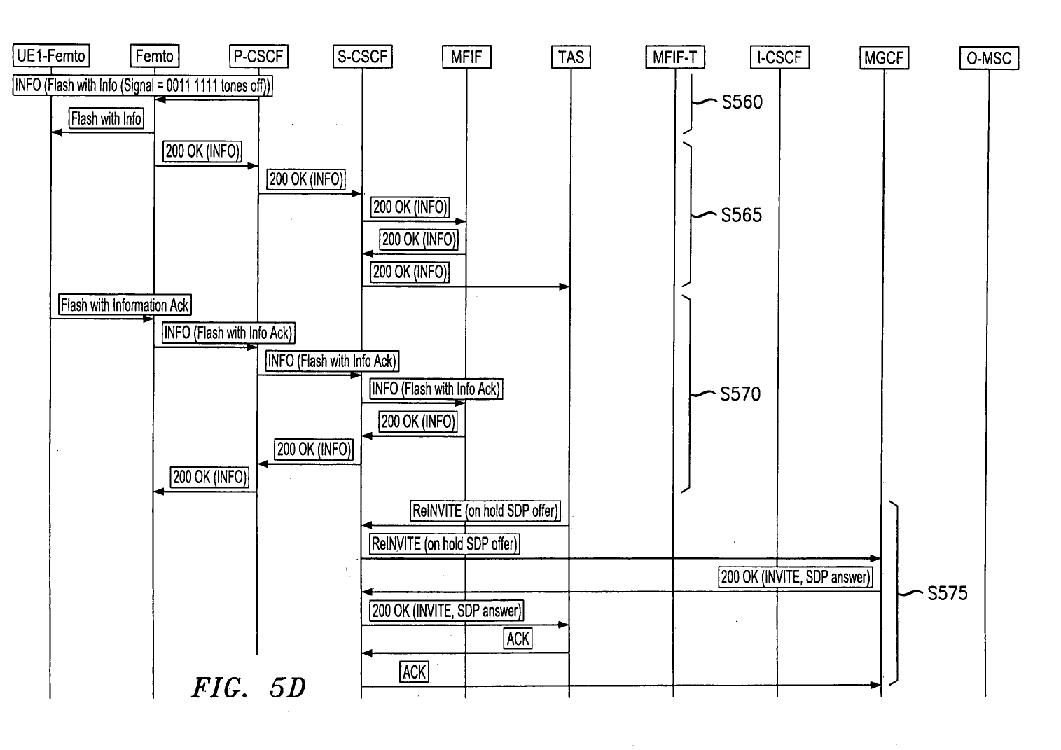

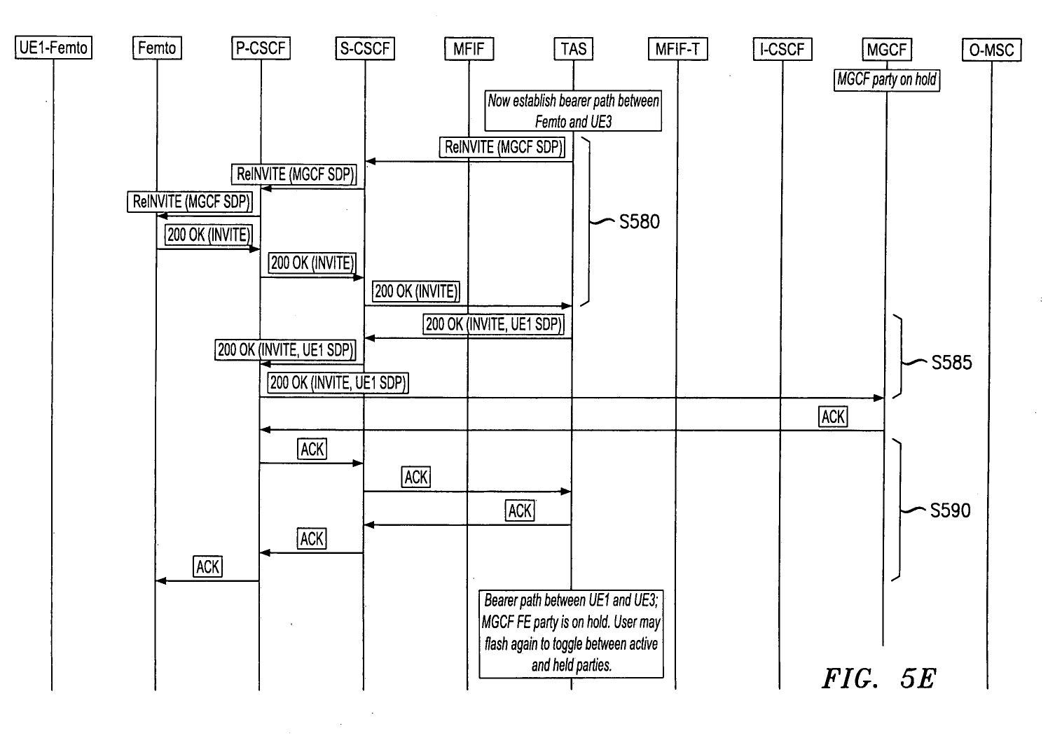

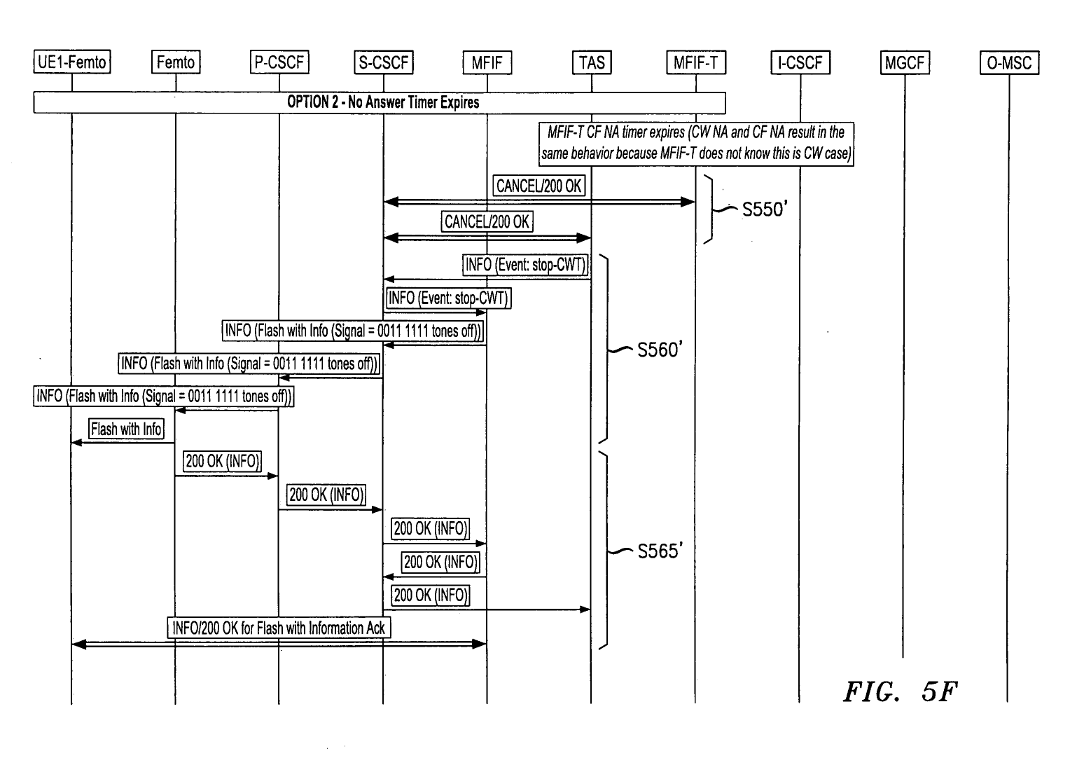

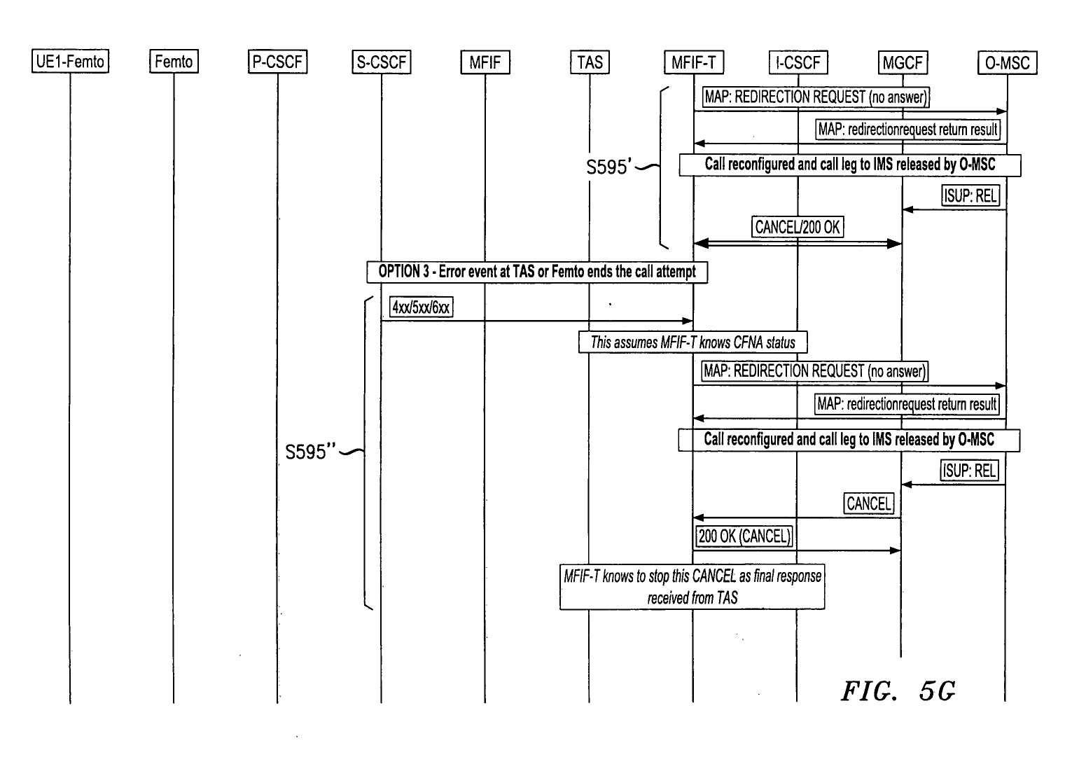

FIGS. 5A-5G illustrate an example embodiment of a method controlling interaction between a TAS and a MFIF when the TAS is providing the call waiting service to a subscriber attached to a femto access point. The IMS may be the IMS network 100 illustrated in FIG. 1.

At S505, a call exists between a first user and a second user. The first user is a UE on a femto cell and the second user may be another mobile subscriber, or an IMS subscriber, or a subscriber in another network. In this example, the second user is in the PSTN network. A MFIF, TAS and MFIF-T may be in the call path. For the purpose of illustration, the MFIF-T indicates terminating functions provided by the MFIF before the INVITE is routed to the TAS, while the MFIF provides functions after the TAS has been involved. In other words, terminating messages pass through the MFIF, then through the TAS, then back through the MFIF, and on toward the user. In order to distinguish the MFIF functions that occur before TAS is involved, the MFIF-T notation is used. In practice, there may be one physical MFIF device involved.

At S510, a new call comes in to the IMS from an O-MSC as an ISUP initial address message (IAM) including a temporary local directory number (TLDN) which is a temporary routing number. As wireless call delivery and TLDN allocation are already well known, a more detailed description will be omitted for the sake of brevity and clarity.

At S515, the TLDN is routed to an I-CSCF in an INVITE message. The I-CSCF then routes the TLDN to an MFIF-T at S520. As stated above, a MFIF and MFIF-T may be the same piece of equipment, but performs different processes. At S520, the MFIF-T retrieves the user ID associated with the TLDN when the TLDN was provided to the O-MSC. The MFIF-T may run the call waiting timer. The user ID is the ID for the mobile station being called so when the TLDN call arrives, the MFIF knows to which user to deliver the call.

The MFIF reformats an INVITE request including a femto ID and user ID of the first user and it is sent to a TAS through an S-CSCF, at S525. Since another call for the first user is already in progress when this new INVITE request is received, the TAS invokes call waiting procedures. The TAS sends a SIP INFO request with an instruction to start the call waiting tone to the MFIF, at S530. In FIGS. 5A-5G, call waiting is used as an example of a service, however, it should be understood that other services may used in FIGS. 5A-5G such as call forwarding or terminating call barring restrictions.

At S535, the MFIF receives the INFO request that contains an instruction to start the call waiting tone, and then sends an INFO request to the femto to instruct the femto to begin playing the call waiting tone. 200 OK acknowledgments for the INFO are then routed from the femto to the P-CSCF, from the P-CSCF to the S-CSCF, from the S-CSCF to the MFIF, from the MFIF to the S-CSCF and from the S-CSCF to the TAS. The TAS then sends 180 Ringing responses for the INVITE to the S-CSCF, from the S-CSCF to the MFIF-T, from the MFIF-T to the MGCF and from the MGCF to the O-MSC, at S540.

At S545, the mobile device sends acknowledgement that the INFO was received to the femto, and the femto sends an INFO with information through to the P-CSCF, from the P-CSCF to the S-CSCF and from the S-CSCF to the MFIF. Acknowledgments are then sent back to the S-CSCF, the P-CSCF and the femto.

From S545, the first user may decide whether to answer the call, at S550, or not answer the call, at S550′. Furthermore, if an error occurs at the TAS or femto, the call attempt is ended, at S550″.

At S550, the first user sends a flash to answer the call waiting call received from the third user. The femto sends the flash with information to the P-CSCF, from the P-CSCF to the S-CSCF and from the S-CSCF then to the MFIF. The MFIF then sends a SIP INFO request through the S-CSCF to the TAS, with an INFO message body with Content-Type application/hook-flash. At S555, acknowledgments are sent from the TAS to the S-CSCF, from the S-CSCF to the MFIF, from the MFIF to the S-CSCF, from the S-CSCF to the P-CSCF and from the P-CSCF to the femto.

At S560, the TAS sends a SIP INFO to the MFIF with an instruction to stop playing the call waiting tone. The MFIF then converts the information from the TAS into a flash with information that the femto understands. The flash with information is sent from the MFIF to the S-CSCF, from the S-CSCF to the P-CSCF, from the P-CSCF to the femto and from the femto to the first user. 200 OK acknowledgments are then sent from the femto to the P-CSCF, from the P-CSCF to the S-CSCF, from the S-CSCF to the MFIF, from the MFIF to the S-CSCF and from the S-CSCF to the TAS, at S565.

At S570, the mobile device sends acknowledgement that the INFO was received at the femto, and the femto sends an INFO with information through the P-CSCF and S-CSCF to the MFIF. At S570, the user indicates that the user wishes to accept the call. Acknowledgments are then sent to the S-CSCF, from the S-CSCF to the P-CSCF and then from the P-CSCF to the femto.

In parallel with the steps that acknowledge receipt of the INFO after the user flashed to accept the call waiting call (S550 through S570), the TAS puts the active call on hold by sending a REINVITE including an on hold SDP offer to the S-CSCF which routes the REINVITE to the MGCF, at S575. The TAS generates the on-hold SDP offer. The MGCF sends a 200 OK response with an SDP answer to the S-CSCF, which routes the 200 OK to the TAS. The TAS sends a SIP ACK back to the MGCF acknowledging receipt of the 200 OK and the MGCF is placed on hold.

At S580, the TAS begins the process to establish an RTP bearer path between the first user and the third user. The TAS sends a REINVITE to the femto including the MGCF SDP offer that had been received in the INVITE (in S525) and the femto sends a 200 OK with SDP answer back to the TAS.

At S585, the TAS sends a 200 OK toward the MGCF to indicate that the call from the third user has been answered. The 200 OK includes the SDP answer provided by the femto.

At S590, an acknowledgment is sent from the MGCF to the femto through the P-CSCF, S-CSCF, MFIF, and TAS. The bearer path between the first user and the third user is established. The second user is on hold. The first user may flash again to toggle between the second and third parties.

When the first user does not answer the call, the call waiting timer expires, at S550′. When the call waiting timer expires at the MFIF-T, a SIP CANCEL request is sent. At S560′, the call waiting tone is stopped by the TAS and associated information is sent to the MFIF. S560′ is the same as S560. S565′ is the same as S565. Therefore, a more detailed description of S560′ and S565′ will not be provided for the sake of brevity and clarity.

At S595′, the MFIF-T sends a REDIRECTION REQUEST to the O-MSC. The REDIRECTION REQUEST is a MAP message sent by an MSC when call forwarding is to occur, telling the O-MSC to reconfigure the call toward the forward to destination. The O-MSC returns a result to the REDIRECTION REQUEST to the MFIF-T. The O-MSC releases the facilities between the serving MSC and O-MSC by sending an ISUP: REL to the MGCF, which releases the call leg toward the servings system (IMS/MFIF).

If an error occurs at the TAS or Femto in the method of FIGS. 5A-5G, S595″ is implemented also resulting in a REDIRECTION REQUEST and call reconfiguration. As is understood by one of ordinary skill, 4xx/5xx/6xx, as illustrated, at S595″, is common nomenclature to cover all the error cases that indicate the call cannot be completed to the SIP endpoint.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). This applies to the figures as well. For example, a node connected to another node by a line in a figure may include other intervening nodes or elements between the node and the another node.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments are presented in terms of software, or algorithms and symbolic representations of operation on data bits within a computer memory. These descriptions and representations are the ones by which those of ordinary skill in the art effectively convey the substance of their work to others of ordinary skill in the art. Usually, though not necessarily, physical manipulations of physical quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As described above, wireless subscriber services may be provided in an IMS. The wireless subscriber services may be provided in an IMS based dual mode (e.g. CDMA/Voice over Wi-Fi) services and/or CDMA Femto Access Point. More specifically, wireless subscriber services may be provided in a system including a wireless network interworking server (MFIF) and a wireline supplementary services application server (TAS).

Example embodiments being thus described, it will be obvious that the same may be varied in many ways. Such variations are not to be regarded as a departure from the spirit and scope of the example embodiments, and all such modifications as would be obvious to one skilled in the art are intended to be included within the scope of the claims.

What is claimed is:

1. A system for providing wireless services to a first user on the system, the system comprising:
a first application server coupled to a home location register and configured to provide wireless services to the first user, the home location register being configured to store information regarding the first user; and
a second application server configured to provide wireline services to the first user and coupled to a media resource function, the media resource function configured to produce tones and announcements, the second application server being further configured to interact with the first application server to provide an interface to the media resource function.

2. The system of claim 1, wherein the first application server is configured to receive a request from the first user to activate a service.

3. The system of claim 2, wherein the first application server is configured to determine the service based on the request and a list of activation codes stored in the first application server and send an instruction to the second application server to provide the service.

4. The system of claim 3, wherein the instruction sent to the second application server is a failure or success string.

5. The system of claim 4, wherein the second application server is configured to determine a tone or announcement to be played based on the failure or success string.

6. The system of claim 1, wherein the first application server is configured to receive a call request from a third user during an existing call between the first user and the second user and transmit an instruction to the second application server to provide a call waiting tone.

7. The system of claim 1, wherein the second application server is configured to receive a request from the first user to make a second call during a first call between the first user and a second user and transmit an instruction to the media resource function to place the first call on hold based on the request.

8. A method for providing wireless services to a first user on a system, the method comprising:
receiving, at a first application server, a request from the first user to activate a service, the first application server being configured to provide wireless services to the first user;
determining, at the first application server, a service to provide based on the request; and
sending, from the first application server, an instruction to a second application server to provide the service based on the determining step, the second application server being configured to provide wireline services to the first user and interact with the first application server to provide an interface to a media resource function configured to produce tones and announcements associated with the service.

9. The method of claim 8, wherein the determining step includes determining the service to provide based on a list of activation codes stored in the first application server.

10. The method of claim 9, wherein the determining step includes transmitting a feature request to a home location register if the request matches an activation code in the list of activation codes.

11. The method of claim 10, wherein the sending step includes replacing data in the request with a failure or success string based on a result of the feature request.

12. The method of claim 8, wherein the sending step includes replacing data in the request with a failure or success string.

13. The method of claim 12, wherein the sending step includes sending the failure or success string to the second application server to associate the failure or success string with a tone.

14. The method of claim 8, wherein the receiving step includes receiving a call request as the request during an existing call between the first user and a second user.

15. The method of claim 14, wherein the sending step includes replacing data in the request with a failure or success string and sending the failure or success string to the second application server to associate the failure or success string with a tone.

16. The method of claim 15, further comprising:
transmitting, from the second application signal, a reinvite signal to connect the first user to the media resource function.

17. A method for providing wireless services to a first user on a system, the method comprising:
first receiving, at a first application server, a call request from a third user during an existing call between the first user and a second user, the first application server being configured to provide wireless services to the first user and a second application server being configured to provide wireline services to the first user and interact with a first application server to provide an interface to a media resource function configured to produce tones and announcements;
first transmitting, by the first application server, to the second application server an invite to answer the call request from the third user;
second receiving, at the first application server, an instruction from the second application server to start a call waiting tone; and
second transmitting, by the first application server, a reinvite signal to reestablish the first call.

18. The method of claim 17, wherein the first receiving the call request includes,
first receiving an initial address message including a temporary routing number.

19. The method of claim 17, further comprising:
third receiving, at the first application server, a flash signal from the first user to answer the call request from the third user.

20. The method of claim 19, wherein the third receiving includes,
third receiving an instruction from the second application server to terminate the call waiting tone.
